(19) United States
(12) Patent Application Publication
(10) Pub. No.: US 2007/0133647 A1
(43) Pub. Date: Jun. 14, 2007

(54) Wavelength modulated laser

(76) Inventor: Andrew Daiber, Emerald Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/240,938

(22) Filed: Sep. 30, 2005

(51) Int. Cl. H01S 3/10; H01S 3/08

(52) U.S. Cl. 372/99; 372/20; 372/102

(57) ABSTRACT

A laser includes an end reflector optically coupled to a front reflector, the front reflector and the end reflector to define a laser cavity. An optical path length modulation section is optically coupled between the front reflector and the end reflector, the optical path length modulation section to change between a first optical path length and a second optical path length to switch an optical output of the laser between a first wavelength and a second wavelength. A filter is optically coupled to the optical output of the laser to remove the second wavelength from the optical output.

### TECHNICAL FIELD

Embodiments of the invention relate to the field of lasers and more specifically, but not exclusively, to a wavelength modulated laser.

### BACKGROUND

Optical transmission systems are used in telecommunication and enterprise networks to transfer data and/or voice communications. Optical signals provide high-speed, superior signal quality, and minimal interference from outside electro-magnetic energy. Optical networks utilizing Dense Wavelength Division Multiplexed (DWDM) systems offer multi-channel optical links.

Optical networks often include light sources, such as lasers. A laser commonly used today is an external cavity tunable laser. The optical output from a light source may be modulated with a data signal and the modulated optical signal sent onto an optical network.

On-off keying (OOK) is a common laser modulation scheme. OOK may be implemented using direct modulation or external modulation. Direct modulation involves turning the light source “on and off”; commonly referred to as non-return to zero (NRZ) signaling. External modulation involves putting a modulator in front of the light source to create the on-off effect, however, the light source continually emits an optical output. External modulation is often favored over direct modulation because of the high chirp associated with direct modulation.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating an external cavity tunable laser having wavelength modulation in accordance with an embodiment of the present invention.

FIG. 2 is a diagram illustrating Vernier tuning in accordance with an embodiment of the present invention.

FIG. 3 is a diagram illustrating a plan view of an external cavity tunable laser having wavelength modulation in accordance with an embodiment of the present invention.

FIG. 3B is a diagram illustrating a cut-away side view of a waveguide in accordance with an embodiment of the present invention.

FIG. 4 is a diagram illustrating channel boundaries in accordance with an embodiment of the present invention.

FIG. 5A is a diagram illustrating wavelength modulation in accordance with an embodiment of the present invention.

FIG. 5B is a diagram illustrating wavelength modulation in accordance with an embodiment of the present invention.

FIG. 6 is a diagram illustrating a plan view of a fully integrated tunable laser having wavelength modulation in accordance with an embodiment of the present invention.

FIG. 7 is a diagram illustrating a system including a tunable laser having wavelength modulation in accordance with an embodiment of the present invention.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following description and claims, the term “coupled” and its derivatives may be used. “Coupled” may mean that two or more elements are in direct contact (physically, electrically, magnetically, optically, etc.). “Coupled” may also mean two or more elements are not in direct contact with each other, but still cooperate or interact with each other.

Embodiments of the invention provide wavelength modulation of a laser. The laser is configured to shift the laser's optical output between two wavelengths. The two wavelengths correspond to two distinct laser modes. One of the two outputted wavelengths may be filtered out and the remaining wavelength transmitted as an amplitude modulated optical signal. As discussed below, embodiments of the invention provide modulation without using external modulators, such as a Mach-Zehnder Modulator (MZM).

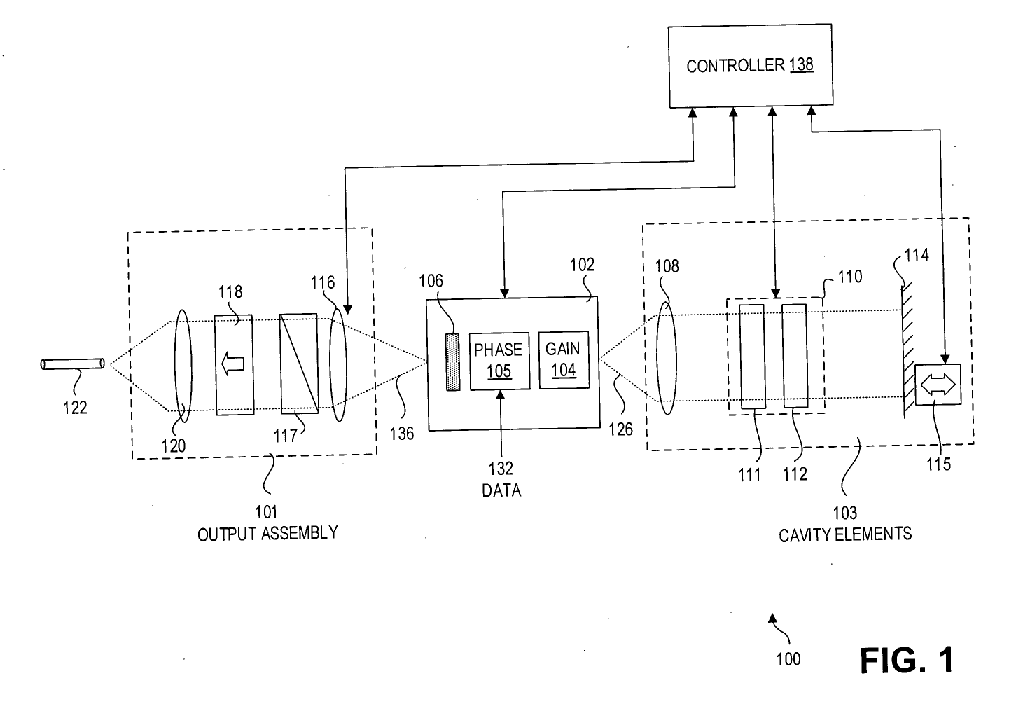

Turning to FIG. 1, an embodiment of a tunable laser 100 having wavelength modulation is shown. As will be discussed below, laser 100 is structured similarly to an external cavity laser. Laser 100 includes cavity elements 103 optically coupled to an integrated structure 102. Integrated structure 102 is optically coupled to an output assembly 101. A controller 138 may be coupled to integrated structure 102, cavity elements 103, output assembly 101, or any combination thereof. Controller 138 may include a conventional processor to receive and send control signals to components of laser 100.

Integrated structure 102 includes a gain section 104, a phase control section 105, and a front reflector 106. In one embodiment, gain section 104, phase control section 105, and front reflector 106 of integrated structure 102 are formed on one or more semiconductor substrates. Embodiments herein also include a “monolithically” integrated structure 102 where components of integrated structure 102 are formed on a single semiconductor substrate. In another embodiment, integrated structure 102 may be packaged for mounting to a printed circuit board.

Gain section 104 emits an optical beam 126 that is collimated by lens 108. Light from optical beam 126 is reflected from end reflector 114 back to gain 104 and to front reflector 106. Front reflector 106 is partially-reflective. The laser cavity of laser 100 is defined by front reflector 106 and end reflector 1 14. As discussed further, below phase control section 105 may be used to change the optical cavity length and thus, change the lasing mode of laser 100.

Cavity elements 103 include end reflector 1 14, a tuner 1 10, and lens 108. End reflector 114 may include a reflector, grating, prism, or the like. In another embodiment, end reflector 114 may be curved such that lens 108 may be eliminated.

The basic operation of tunable laser 100 is as follows. A controllable current is supplied to gain section 104 which produces an emission of optical energy. The emitted optical energy passes back and forth between front reflector 106 and end reflector 1 14. As the optical energy passes back and forth, a plurality of resonances, or “lasing” modes are produced. Under a lasing mode, a portion of the optical energy temporarily occupies the external laser cavity; at the same time, a portion of the energy in the external laser cavity eventually passes through partial front reflector 106. The energy that exits the laser cavity through the partial reflector 106 results in optical output 136.

Optical output 136 passes through output assembly 101 and into an optical fiber 122. Optical output 136 is collimated by lens 116 and focused by lens 120. In one embodiment, an optical isolator 1 18 is positioned between lens 1 16 and lens 120. In one embodiment, optical isolator 118 prevents reflections from returning toward integrated structure 102. Optical output 136 is focused by lens 120 into optical fiber 122. In one embodiment, optical fiber 122 is supported by a ferrule (not shown).

In another embodiment, a beam splitter 117 is positioned between lens 116 and 120 to pick off a portion of optical output 136 such that the intensity of the split-off portion can be measured by a photo-electric device, such as a photodiode. The intensity measured by the photodiode is proportional to the intensity of the output beam. The measured intensity may then be sent to controller 138. Controller 138 may use this signal to make adjustments to other components of laser 100 to maximize or stabilize the optical output power.

In order to produce an output at a single wavelength, filtering mechanisms are employed to substantially attenuate all lasing modes except for the lasing mode corresponding to the desired wavelength. In one embodiment, laser 100 may be tuned to C-band wavelengths (1525-1565 nanometers), L-band wavelengths (1565-1610 nanometers), or both (1525-1610 nanometers). In one embodiment, tuner 110 is thermally tuned using control signals from controller 138. In this particular embodiment, by adjusting the heat to at least a portion of tuner 110, the optical characteristics of tuner 110 are changed to tune laser 100 to various wavelengths.

Tuner 110 may be used to select a pair of laser modes for wavelength modulation. Once the pair of laser modes has been selected by tuner 110, the wavelength of those laser modes relative to tuner 110 can be adjusted relative to the tuner transmission wavelengths by adjusting the optical path length of the laser cavity. This optical path length adjustment may be made by an optical path length modulation section, such as a phase control section 105.

In one embodiment, tuner 110 may include a tuning filter 111 and a tuning filter 112. In one embodiment, filters 111 and 112 are each tunable etalons. In one embodiment, filters 111 and 112 may be referred to as a pair of Vernier tuning filters (discussed further below).

The lasing mode of a laser is a function of the total optical path length between the cavity ends (the cavity optical path length); that is, the optical path length encountered as the light passes through the various optical elements and spaces between those elements and the cavity ends defined by partially-reflective front reflector 106 and end reflector 114. The optical path includes gain section 104, phase control section 105, lens 108, tuner 1 10, plus the path lengths between the optical elements (i.e., the path length of the transmission medium occupying the laser cavity, which is typically a gas such as air). More precisely, the total optical path length is the sum of the path lengths through each optical element and the transmission medium times the coefficient of refraction for that element or medium.

As discussed above, under a lasing mode, photons pass back and forth between the cavity end reflectors at a resonance frequency, which is a function of the cavity optical path length. In fact, without the tuning filter elements, the laser would resonate at multiple frequencies. Longitudinal laser modes occur at each frequency where the roundtrip phase accumulation is a multiple of 2π.

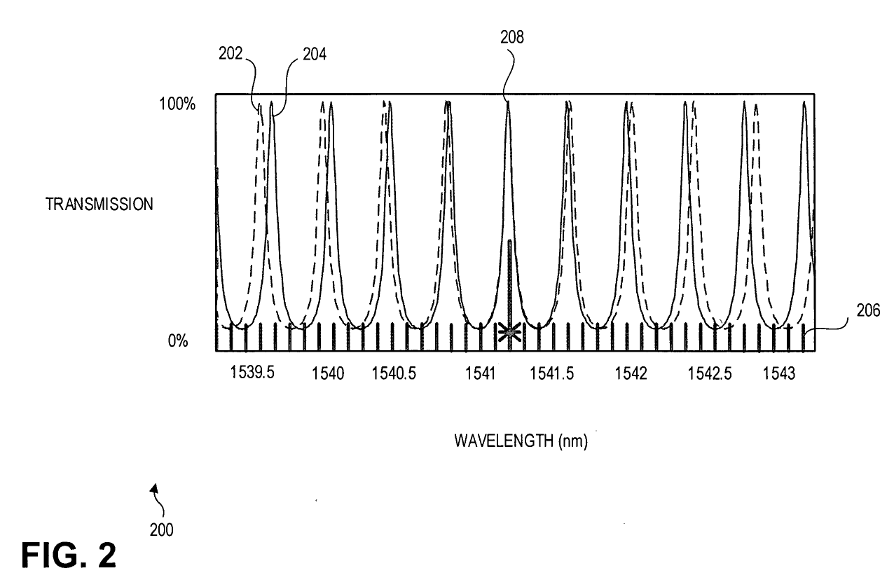

For simplicity, if we model the laser cavity as a Fabry-Perot cavity, these frequencies can be determined from the following equation:

$$L = \frac{λ x}{2 n} \qquad ( 1 )$$

where λ=wavelength, L=optical length of the cavity, x=an arbitrary integer −1, 2, 3, . . . , and n=refractive index of the medium. The average frequency spacing can be derived from equation (1) to yield:

$$Δ v = \frac{c}{2 nL} \qquad ( 2 )$$

where v=c/λ and c is the speed of light. The number of resonant frequencies is determined from the width of the gain spectrum. The corresponding lasing modes for the cavity resonant frequencies are commonly referred to as “cavity modes,” an example of which is depicted in FIG. 2 at 206.

Referring to FIG. 2, an embodiment of conventional Vernier tuning will be discussed to further understanding of embodiments of the invention. However, as discussed below, a laser in accordance with embodiments herein is configured to operate so that when one laser mode occurs at a first transmission peak through one of the tuning filters; the closest laser mode to a second transmission peak through the second tuning filter does not occur exactly at the second transmission peak.

In FIG. 2, configurations of the two etalons are selected such that the respective free spectral ranges of the etalons are slightly different. This enables transmission peaks to be aligned under a Vernier tuning technique.

In FIG. 2, a graph 200 of transmission versus wavelength for Vernier tuning is shown. In the embodiment of graph 200, filters 111 and 112 are configured with a difference in FSR of approximately 3%. Filter 111 may serve as a grid generator and filter 112 may serve as a channel selector. Waveform 202 (shown by a dotted line) corresponds to a filter mode for filter 112 (channel selector) and waveform 204 (shown by a solid line) corresponds to a filter mode for filter 111 (grid generator), where the spacing between transmission peaks for filter 112 (channel selector) are greater than the spacing between transmission peaks for filter 111 (grid generator). Filters 111 and 112 may be thermally tuned.

Lasing occurs where the filter modes overlap with a cavity mode, shown at 208. The cavity modes (also referred to as laser modes) are shown along the horizontal axis at 206.

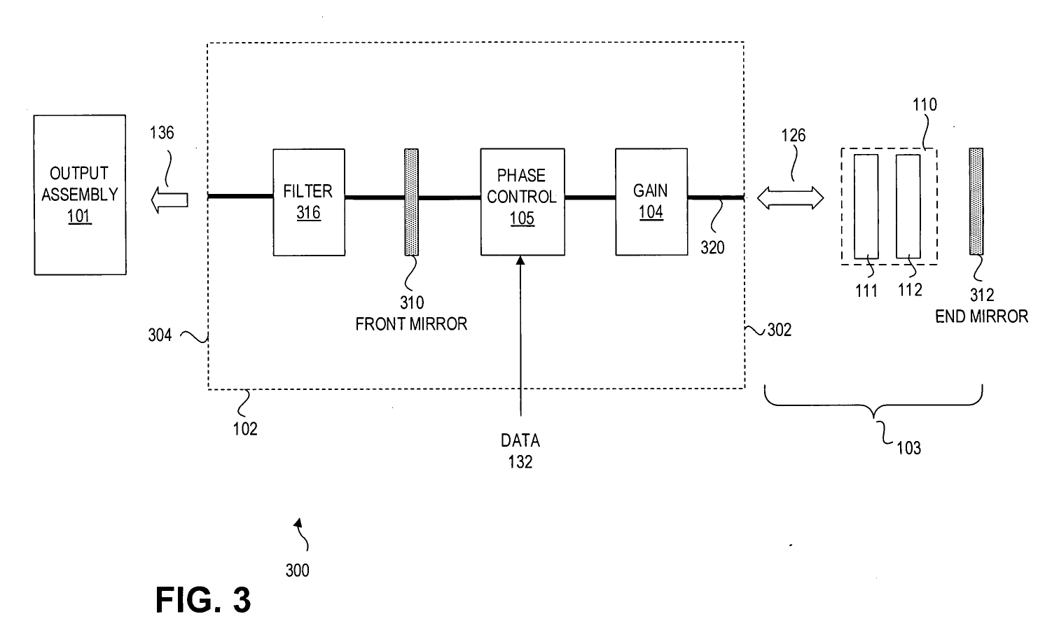

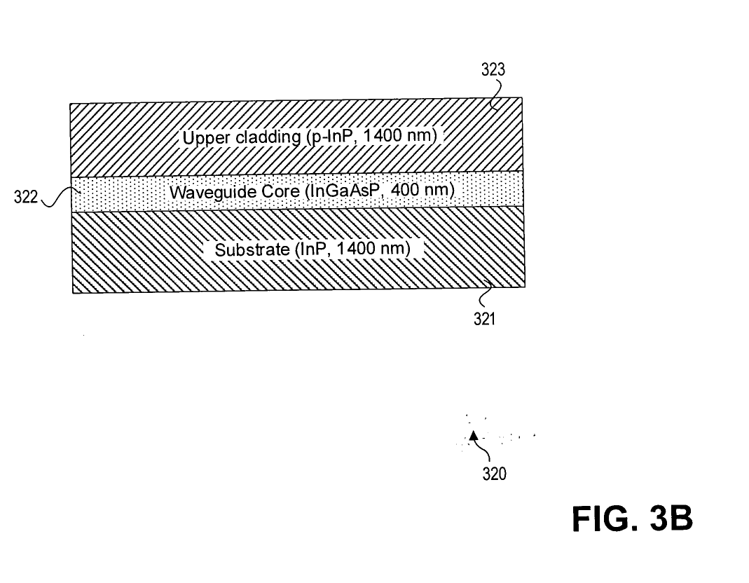

Turning to FIG. 3, an embodiment of a tunable laser 300 is shown. Laser 300 includes integrated structure 102. Integrated structure 102 includes gain section 104, phase control section 105, and a front mirror 310 optically coupled by a waveguide 320. Front mirror 310 may be partially-reflective. Front mirror 310 is an embodiment of front reflector 106.

In one embodiment, waveguide 320 is a semiconductor waveguide. Integrated structure 102 of FIG. 3 also includes a filter 316 optically coupled along waveguide 320. Filter 316 filters out the unwanted wavelength from the two wavelengths alternately emitted from front mirror 310. In one embodiment, filter 316 may be fabricated as a Vernier filter pair. The mean free spectral range of this pair should be selected so that when wavelength is highly transmitted, the other wavelength is substantially attenuated. In alternative embodiments, other tunable and non-tunable technologies that may be used to fabricate filter 316 include thin film dielectric films, reflective surface gratings moved using micro-mechanical devices, or dynamic gratings generated using the acousto-optic effect.

In alternative embodiments, filter 316 may be positioned between integrated structure 102 and output assembly 100, filter 316 may be part of output assembly 101, or filter 316 may be positioned in the optical output after output assembly 101.

Optical beam 126 passes through integrated structure 102 via waveguide 320. Integrated structure 102 includes a front facet 302 and a rear facet 304 connected by waveguide 320. In one embodiment, facets 302 and 304 are non-reflective. Cavity elements 103 include tuner 110 and an end mirror 312. End mirror 310 is an embodiment of end reflector 114.

Front mirror 310 and end mirror 312 define the laser cavity. Light beam 136 exits waveguide 320 and enters output assembly 101. As will be discussed further below, phase control section 105 is used to alter the optical path length of the laser cavity, and thus, change the laser mode.

Different techniques for monolithic integration of laser components, such as gain section 104 and phase control section 105, within integrated device 102 have been developed. To minimize the absorption in the laser component sections, the band-gap of these sections may be broadened by approximately 0.06-0.12 electronvolt (eV) (blue shift of the absorption peak by 100-200 nanometers (nm)) compared to the gain section. This can be done by one of the following techniques. In each of the techniques, the integrated structure comprises a material suitable for forming applicable energy bandgaps. In one embodiment, the integrated structure is formed using an Indium Gallium Arsenic Phosphide (InGaAsP) based material.

A first technique uses an offset Quantum-Well (QW) structure (see, e.g., B. Mason, G. A. Fish, S. P. DenBaars, and L. A. Coldren, “Widely tunable sampled grating DBR laser with integrated electroabsorption modulator”, IEEE Photonics Technology Letters, vol. 11, No. 6, pp. 638-640,1999). In this structure, the multiple quantum-well active layer is grown on top of a thick low band-gap (0.84-0.9 eV) quaternary waveguide. The two layers are separated by a thin (about 10 nm) stop etch layer to enable the QW's to be removed in the phase and modulator sections with selective etching. This low bandgap waveguide provides high index shift for the phase section of the laser at low current densities.

A second technique, known as Quantum Well Intermixing (QWI), relies on impurity or vacancy implantation into the QW region allowing its energy bandgap to be increased (see, e.g., S. Charbonneau, E. Kotels, P. Poole, J. He, G. Aers, J. Haysom, M. Buchanan, Y. Feng, A. Delage, F. Yang, M. Davies, R. Goldberg, P. Piva, and I. Mitchell, “Photonic integrated circuits fabricated using ion implantation”, IEEE J. Selected Topics in Quantum Electronics, vol. 4, No. 4, pp. 772-793, 1998 and S. McDougall, O. Kowalski, C. Hamilton, F. Camacho, B. Qiu, M. Ke, R. De La Rue, A. Bryce, and J. Marsh, “Monolithic integration via a universal damage enhanced quantum-well intermixing technique”, IEEE J. Selected Topics in Quantum Electronics, vol. 4, No. 4, pp. 636-646, 1998). Selective application of QWI to the phase control section provides the required blue shift of the absorption peak of about 100-200 nm. This technique allows for better mode overlap with the quantum wells than the first technique.

A third technique employs asymmetric twin-waveguide technology (see, e.g., P. V. Studenkov, M. R. Gokhale, J. Wei, W. Lin, I. Glesk, P. R. Prucnal, and S. R. Forrest, “Monolithic integration of an all-optical Mach-Zehnder demultiplexer using an asymmetric twin-waveguide structure”, IEEE Photonics Technology Letters, vol. 13, No. 6, pp. 600-603, 2001). In this technique, two optical functions of amplification and phase control are integrated in separate, vertically coupled waveguides, each independently optimized for the best performance.

In one embodiment, front mirror 310 is formed by etching an air gap of a controlled width. In another embodiment, front mirror 310 may include a chirped Bragg grating. Such a chirped Bragg grating using a grating structure similar to a Distributed Bragg Reflector (DBR) laser, except the grating is unevenly spaced (i.e., chirped) so as to produce multiple resonant modes.

Turning to FIG. 3B, a cut-away side view of waveguide 320 in the region of phase control section 105 is shown. A waveguide core 322 is formed on a substrate 321. In one embodiment, substrate 321 includes Indium Phosphide (InP) and waveguide core 322 includes Indium Gallium Arsenic Phosphide (InGaAsP). In another embodiment, waveguide core 322 includes Indium Gallium Aluminum Arsenic (InGaAlAs). It will be appreciated that components of integrated structure 102, such as gain section 104 and phase control section 105, may be formed on substrate 321 using well known techniques.

In the embodiment of FIG. 3B, substrate 321 has a thickness of approximately 1400 nanometers (nm) and waveguide core 322 has a thickness of approximately 400 nm and a width of approximately 370-470 nm. An upper cladding layer 323 is formed over waveguide core 322. In one embodiment, upper cladding layer 323 includes p-type InP having a thickness of approximately 1400 nm.

Embodiments of the invention provide wavelength modulation of a tunable laser. In short, the laser is modulated between two wavelengths, one of which is then absorbed and the other transmitted as an optical data signal. Tuning filters 111 and 112 are adjusted to a “super-mode boundary” where two adjacent filter transmission peaks have equal transmission. The “super-mode boundary” may also be referred to as a channel which is known to the receiver, but this channel is not to be confused with an International Telecommunication Union (ITU) channel. In one embodiment, tuning filters 111 and 112 include conventional “off-the-shelf” Vernier tuning filters.

The cavity length of the laser is configured such that when one laser mode is close to one these transmission peaks, the closest laser mode to the other transmission peak has lower transmission than the first mode. The laser will operate at the wavelength of the first laser mode associated with the first transmission peak because the first laser mode has a higher transmission. In one embodiment, the desired cavity length is configured at manufacturing. In another embodiment, the cavity length may be adjustable once the laser is deployed, such as through an actuator or the like.

The laser may be adjusted to operate close to the second transmission peak, and thus a second wavelength, by changing the phase of the cavity. This phase change changes the optical path length of the laser cavity, and thus, the wavelength of the cavity mode. Adding a small amount of phase (<2π) moves the second laser mode toward the second transmission peak and first laser mode away from the first transmission peak. When the transmission of the second laser mode becomes greater than the transmission of the first laser mode, the laser will lase at the second laser mode. Subsequent subtraction of an equal amount of phase returns the laser modes to their original positions and lasing at the first wavelength.

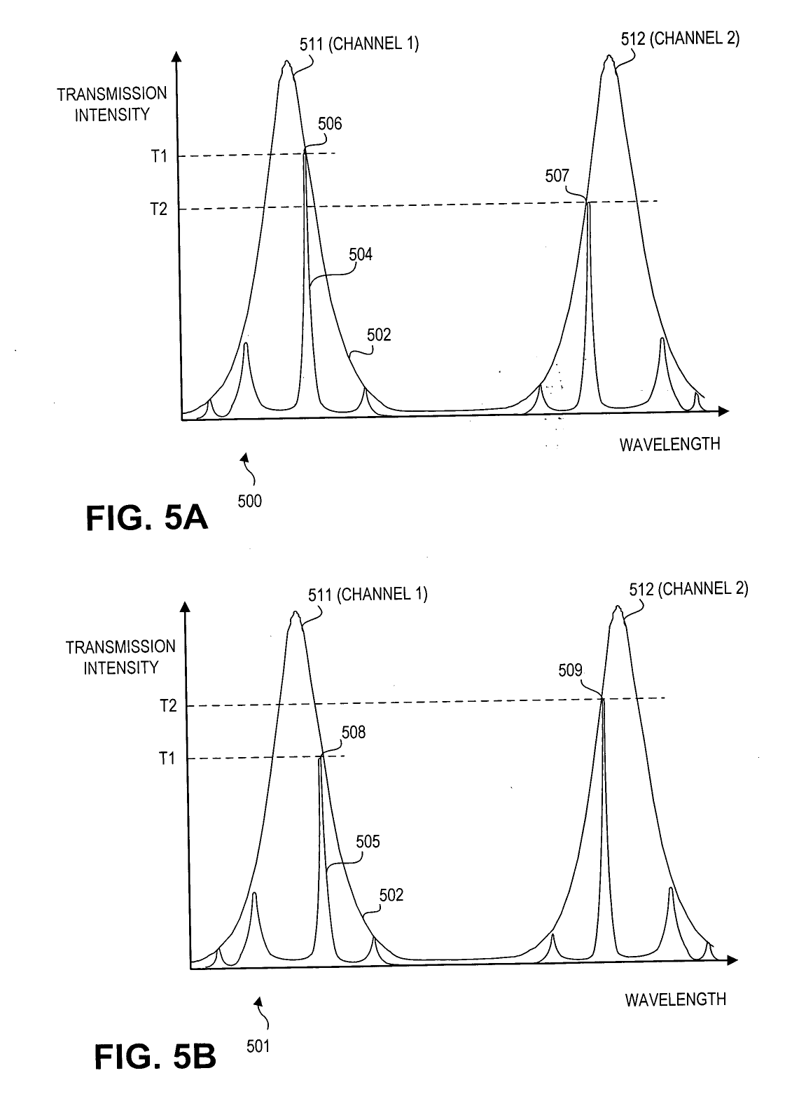

To obtain the greatest relative change in transmission for the smallest wavelength (phase) change, it is generally advantageous to situate the laser modes on opposing slopes of the filter curve such that the change in filter transmission with respect to wavelength for laser mode 1 is opposite in sign to the change in filter transmission with respect to wavelength for laser mode 2 (discussed further below in conjunction with FIGS. 5A and 5B).

The physics of semiconductor lasers may cause the laser to hop wavelengths at a slightly different phase when adding phase then when subtracting phase. This phenomena is known as hysteresis. One mechanism of hysteresis is known to one of ordinary skill in the art as gain saturation. This hysteresis may be reduced by increasing the wavelength separation of the first lasing mode with respect to the second lasing mode.

Another method to limit hysteresis is to design the filter transmission such that the change in filter transmission with respect to optical frequency exceeds a critical value

$$\frac{ⅆ log T ( v )}{ⅆ v} = \frac{{L}_{eff}}{α \cdot v}$$

at some optical frequency, v, and one of the two lasing mode frequencies is modulated across this critical frequency. In this equation, L_{eff}, represents the effective optical path length between the laser end mirrors including group delay effects in the filters, T(v) represents the transmission curve of the filter, and α is the linewidth enhancement factor of the gain medium. When phase is added to the cavity such that the first lasing mode crosses this critical frequency, this lasing mode becomes unstable and vanishes and the laser is forced to operate at the second lasing mode even if the second lasing mode has lower transmission than the first lasing mode at the point it vanishes. When phase is subtracted, lasing will return to the first lasing mode as soon as it becomes stable. This mechanism for hopping modes is immune to gain saturation and exhibits very small hysteresis.

A filter at the output of the laser may remove the undesired wavelength from the optical output. Thus, a single wavelength will appear to “blink” on and off based on the inputted data signal 132. Data signal 132 is applied to the phase control section 132 and not to a conventional modulation section, such as an MZM.

Embodiments of the invention use control of the laser phase to transition between wavelengths. The phase may be adjusted quickly with the phase control section 105 to rapidly change between the first and second wavelengths. Data signal 132 is provided to the phase control section 105 to control the change of phase, and consequently, modulate the change in phase according to the logic of data signal 132.

As current (or voltage) is applied to the phase control section 105, the phase control section 105 creates a phase shift of the laser cavity. In one embodiment, phase control section 105 may be operated in forward bias. In another embodiment, phase control section 105 is reverse biased by applying a voltage (that is, data signal 132) to phase control section 105. In one embodiment, voltage modulation may provide a data rate up to 10 Gigahertz (GHz) in the modulated optical output (that is, 10 Gigabits per second). In another embodiment, the data rate is approximately 2.5 GHz.

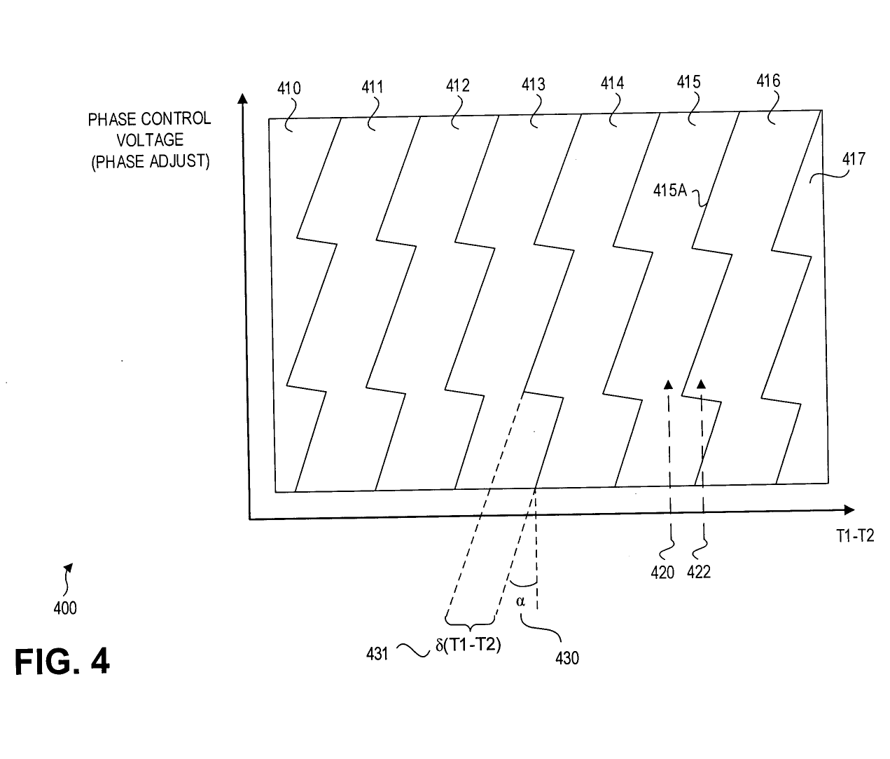

Turning to FIG. 4, a graph 400 in accordance with an embodiment of the invention is shown. The vertical axis of graph 400 shows an applied phase control voltage to adjust the phase of the laser using the phase control section. The horizontal axis shows the temperature difference between etalons 111 and 112 in degrees Celsius. Graph 400 also shows transmitted wavelengths in the zigzag sections 410-417. Each section 410-417 corresponds to a channel. The lines between sections correspond to channel boundaries. For example, line 415A shows a channel boundary between sections 415 and 416. A boundary tilt angle (α) is shown at 430. A mode hop location δ(T1-T2) is shown at 431.

In one embodiment, each section 410-417 is 275 GHz apart in wavelength frequency. This is the Vernier tuning distance between channels. Thus, as (T1-T2) is adjusted on the horizontal axis, the laser jumps laser modes and tunes by 275 GHz.

The tilted channel boundaries in graph 400 are used to facilitate wavelength modulation. For example, if the laser is centered on the wavelength in section 415, shown by vertical line 420, then a change to the phase control voltage will not affect a wavelength change. That is, moving vertically along line 420 using phase control will not cause a change in the laser wavelength.

However, if the laser is tuned to operate near the channel boundary 415A, shown by vertical line 422, then a change in the phase control voltage will cause the laser to jump between the wavelengths of section 415 and 416. Thus, embodiments herein take advantage of the zigzag, tilted channel boundaries as shown in graph 400.

It will be appreciated that embodiments herein do not operate where the transmission peaks of the pair of filters perfectly align. In FIG. 4, vertical line 420 represents where the transmission peaks perfectly align at the center of the wavelength. A vertical line exactly between the centers of two adjacent wavelengths represents where there are two transmission peaks of equal intensity as used by embodiments of the invention. The zigzag tilted channel boundary facilitates modulating between the two transmission peaks (wavelengths) using cavity phase control.

In one embodiment, laser 300 is configured such that end mirror 312 is positioned at a distance from front mirror 310 to create the zigzag tilted channel boundary used for wavelength modulation. In one embodiment, end mirror 312 is positioned 150 microns closer to front mirror 310 than an ideal position of 14 millimeters between mirrors 310 and 312 for conventional Vernier tuning. Placing mirrors 310 and 312 slightly closer together than a nominal position for conventional Vernier tuning creates the tilted channel boundary effect described above in conjunction with FIG. 4. In alternative embodiments, the mirrors 310 and 312 may be positioned slightly further apart than a nominal position for conventional Vernier tuning.

In another embodiment, for conventional Vernier tuning, laser 300 is manufactured such that a ratio between the cavity length and the thickness of a tuning filter is 27:1. In embodiments herein, the cavity length is manufactured slightly less than this ratio to produce the channel boundary effect.

Turning to FIGS. 5A and 5B, graphs 500 and 501, respectively, illustrate embodiments of wavelength modulation. The vertical axis shows transmission intensity (also called just “transmission”) and the horizontal axis shows wavelength. A waveform 502 having a transmission peak 511 and a transmission peak 512 is shown. Transmission peaks 511 and 512 may each correspond to a standardized wavelength channel, shown as channels 1 and 2 in FIGS. 5A and 5B. In one embodiment, a pair of Vernier tuning filters 111 and 112 is adjusted to the two adjacent filter transmission peaks 511 and 512 having equal transmission. Waveform 502 shows the product of the transmission peaks of each of the Vernier tuning filters 111 and 112. Waveform 502 may also be referred to as the filter curve.

The laser modes are shown by waveform 504. On the vertical axis, T1 and T2 correspond to transmission intensity of laser modes at or near the transmission peaks.

In graph 500, the laser will lase at the wavelength corresponding to laser mode 506 (channel 1) because laser mode 506 has more transmission intensity than laser mode 507. The cavity length of the laser is constructed so that when laser mode 506 is at its highest point for channel 1, laser mode 507 is below it highest point for channel 2.

As phase is added (or subtracted), the laser modes will start to translate. In graph 501, waveform 505 shows the laser modes after the cavity phase has been changed. In graph 501, laser mode 509 has more intensity than laser mode 508. The laser will lase at the wavelength corresponding to laser mode 509. To return to lasing at laser mode 506, the cavity phase is adjusted back. If 2π of phase is added, the laser modes will have completely cycled and the waveform 504 will appear again.

The mode spacing of the laser is such that both laser modes, corresponding to transmission peaks 511 and 512, cannot peak at the same time. The laser mode spacing is a function of the cavity length. By using phase control, the laser oscillates between the wavelengths associated with transmission peaks 511 and 512.

The oscillation may be based on data signal 132 applied to phase control section 105. For example, when data signal 132 is a logical ‘1’, channel 1 will lase as in FIG. 5A. When data signal 132 is a logical ‘0’, channel 1 will not lase as in FIG. 5B. If the wavelength associated with channel 1 is the desired wavelength, then the wavelength associated with channel 2 is filtered out so that only a modulated channel 1 will be transmitted.

Embodiments of lasers herein may be compatible with broad tunability. For example, laser 300 may be fully-tunable across the C-band. Tuner 110 may be tuned to any adjacent channels in the C-band for generating a wavelength modulated signal. Filter 316 may also be tuned accordingly to remove the undesired wavelength from the optical output.

Embodiments herein do not use an external modulator, such as an MZM or Electro-Absorber (EA), saving cost, complexity and wavelength restrictions. Embodiments herein avoid the large chirp associated with direct modulation designs by using constant bias current and maintaining high photon densities in the laser cavity at all times. Embodiments of the invention may have chirp of 1 GHz or less which is comparable to external modulator devices.

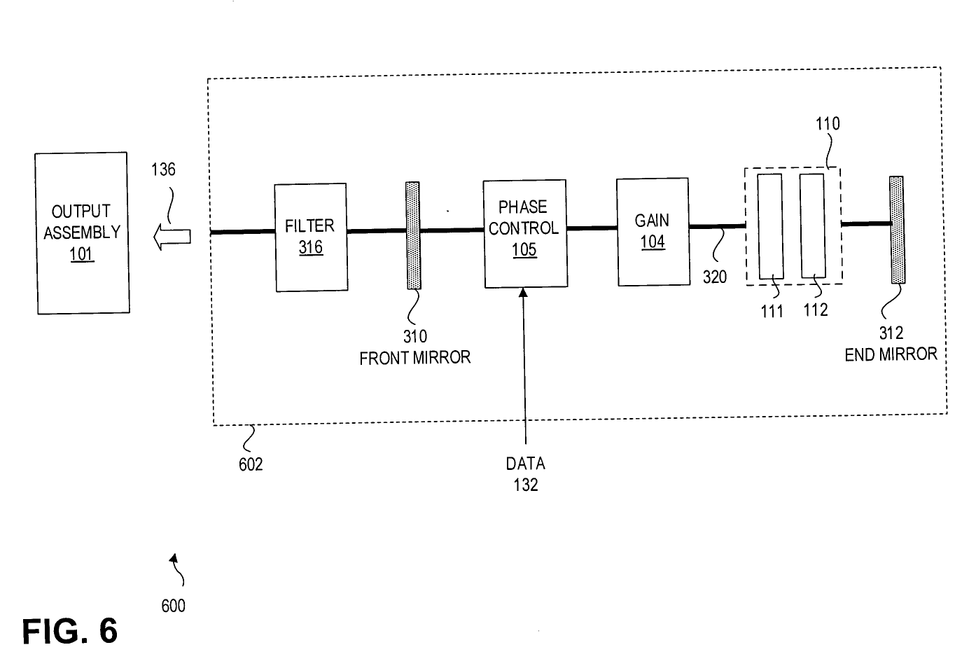

Turning to FIG. 6, an embodiment of a fully-integrated, fully tunable laser 600 is shown. An embodiment of laser 600 includes a Sampled Grating Distributed Bragg Reflector (SGDBR) laser. Laser 600 is similar to laser 300. However, the cavity elements 103 have been integrated onto semiconductor substrate 602 and are optically coupled be waveguide 320.

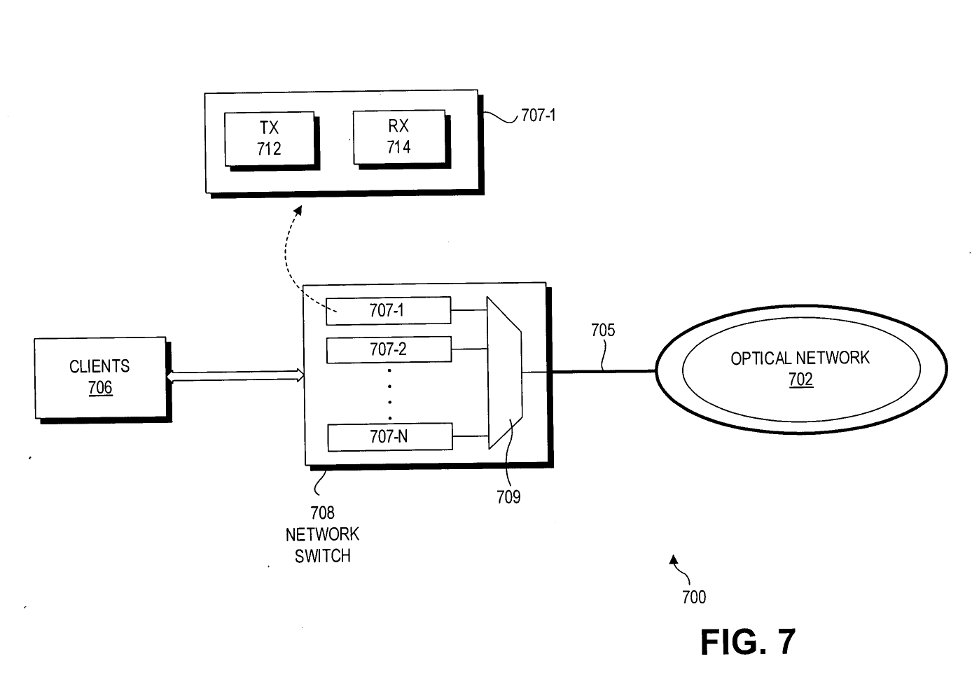

Referring to FIG. 7, a system 700 in accordance with one embodiment of the present invention is shown. System 700 includes a network switch 708 coupled to an optical network 702 via optical link 705. In one embodiment, optical link 705 includes one or more optical fibers. Network switch 708 is also coupled to one or more clients 706. Embodiments of client 706 include a router, a server, a host computer, a phone system, or the like.

Network switch 708 includes transponders 707-1 to 707-N coupled to a multiplexer/demultiplexer 709. A transponder 707 converts between optical signals of optical network 702 and electrical signals used by clients 706. Multiplexer/demultiplexer 709 is a passive optical device that divides wavelengths (or channels) from a multi-channel optical signal, or combines various wavelengths (or channels) on respective optical paths into one multi-channel optical signal depending on the propagation direction of the light. In one embodiment, system 700 employs Wavelength Division Multiplexing (WDM), Dense Wavelength Division Multiplexing (DWDM), Frequency Division Multiple Access (FDMA), or the like.

Each transponder 707 may include an optical transmitter (TX) 712 and an optical receiver (RX) 714. In one embodiment, optical transmitter 712 includes a laser having wavelength modulation as described herein.

Various operations of embodiments of the present invention are described herein. These operations may be implemented by a machine using a processor, an Application Specific Integrated Circuit (ASIC), a Field Programmable Gate Array (FPGA), or the like. In one embodiment, one or more of the operations described may constitute instructions stored on a machine-readable medium, that when executed by a machine will cause the machine to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description. The terms used in the following claims should not be construed to limit the invention to the specific embodiments disclosed in the specification. Rather, the following claims are to be construed in accordance with established doctrines of claim interpretation.

1. (canceled)

2. The external cavity tunable laser of claim 11 wherein the optical path length modulation section includes a phase control section, wherein the phase control section to change between the first optical path length and the second optical path length in response to a data signal.

3. (canceled)

4. The external cavity tunable laser of claim 11, wherein the first and second transmission peaks are adjacent and have substantially equal transmission.

5. The external cavity tunable laser of claim 4 wherein a cavity length of the laser cavity is configured to cause a first laser mode closest to the first transmission peak to have higher transmission intensity than a second laser mode closest to the second transmission peak, wherein the first laser mode corresponds to the first wavelength.

6-8. (canceled)

9. The external cavity tunable laser of claim 11 wherein the laser is tunable across the C-band

10. The laser of claim 11 wherein a data rate of the optical output at the first wavelength is up to approximately 10 Gigahertz.

11. An external cavity tunable laser, comprising:
cavity elements including an end mirror and a pair of Vernier tuning filters, wherein the pair of Vernier tuning filters are tunable to a first transmission peak and a second transmission peak, wherein the first and second transmission peaks are adjacent and have substantially equal transmission;
an output assembly; and
an integrated structure including front and rear facets optically coupled by a waveguide passing through the integrated structure, the cavity elements optically coupled to the front facet, the output assembly optically coupled to the rear facet, the integrated structure including:
a gain section;
a front mirror optically coupled to the gain section by the waveguide, the front mirror to emit an optical output, the front mirror and the end mirror to define a laser cavity;
a phase control section optically coupled between the gain section and the front mirror, the phase control section to change the optical output between a first wavelength associated with the first transmission peak and a second wavelength associated with the second transmission peak in response to a data signal and;
a filter optically coupled to the front mirror by the waveguide to remove the second wavelength from the optical output.

12. (canceled)

13. The external cavity tunable laser of claim 11, further comprising an external filter positioned in the optical output to remove the second wavelength from the optical output.

14. The external cavity tunable laser of claim 11 wherein a cavity length of the laser cavity is configured to cause a first laser mode closest to the first transmission peak to have higher transmission intensity than a second laser mode closest to the second transmission peak, wherein the first laser mode corresponds to the first wavelength.

15. The external cavity tunable laser of claim 11 wherein the phase control section is operated in reverse bias.

16. The external cavity tunable laser of claim 11 is tunable across the C-band.

17. A system, comprising:
an optical fiber; and
a switch coupled to the optical fiber, the switch including a tunable laser, the tunable laser including:
an end reflector;
a gain section optically coupled to the end reflector;
a front reflector optically coupled to the gain section, the front reflector to emit an optical output, the front reflector and the end reflector to define a laser cavity;
a pair of Vernier tuner elements optically coupled between the end reflector and the gain section, the tuner tunable to a first transmission peak and a second transmission peak, wherein the first and second transmission peaks are adjacent and have substantially equal transmission;
a phase control section optically coupled between the gain section and the front reflector, the phase control section to change the optical output between a first wavelength associated with the first transmission peak and a second wavelength associated with the second transmission peak in response to a data signal; and
a filter optically coupled to the front reflector to remove the second wavelength from the optical output.

18. The system of claim 17, further comprising a filter positioned in the optical output to remove the second wavelength from the optical output.

19. The system of claim 17 wherein a cavity length of the laser cavity is configured to cause a first laser mode closest to the first transmission peak to have higher transmission intensity than a second laser mode closest to the second transmission peak, wherein the first laser mode corresponds to the first wavelength.

20. The system of claim 17, further comprising a controller coupled to the tuner to tune the tunable laser.
